(19) United States
(12) Patent Application Publication
(10) Pub. No.: US 2009/0066822 A1
(43) Pub. Date: Mar. 12, 2009

(54) Image Sensor and Method for Manufacturing the Same

(76) Inventor: JOON HWANG, Cheongju-si (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/204,919

(22) Filed: Sep. 5, 2008

(30) Foreign Application Priority Data
Sep. 7, 2007 (KR) 10-2007-0090833
Jun. 9, 2008 (KR) 10-2008-0053848

(51) Int. Cl. H04N 5/335

(52) U.S. Cl. 348/294; 348/E05.091

(57) ABSTRACT

Provided is an image sensor. The image sensor comprises a first substrate, and an image sensing device on the first substrate. The first substrate includes an interconnection and a readout circuitry. The image sensing device is formed on the interconnection. A top electrode is provided on the image sensing device such that reverse bias can be applied to the top side of the image sensing device.

### CROSS-REFERENCE TO RELATED APPLICATIONS

The present application claims the benefit under 35 U.S.C. §119 of Korean Patent Application No. 10-2007-0090833, filed Sep. 7, 2007, and No. 10-2008-0053848, filed Jun. 9, 2008, which are hereby incorporated by reference in their entirety.

### BACKGROUND

An image sensor is a semiconductor device for converting an optical image into an electrical signal. The image sensor is roughly classified as a charge coupled device (CCD) image sensor or a complementary metal oxide semiconductor (CMOS) image sensor (CIS).

In a related art, a photodiode is formed in a substrate with transistor circuitry using ion implantation. As the size of a photodiode reduces more and more for the purpose of increasing the number of pixels without an increase in a chip size, the area of a light receiving portion reduces, so that an image quality reduces.

Also, since a stack height does not reduce as much as the reduction in the area of the light receiving portion, the number of photons incident to the light receiving portion also reduces due to diffraction of light, called airy disk.

As an alternative to overcome this limitation, an attempt of forming a photodiode using amorphous silicon (Si), or forming a readout circuitry in a Si substrate and forming a photodiode on the readout circuitry using a method such as wafer-to-wafer bonding has been made (referred to as a “three-dimensional (3D) image sensor). The photodiode is connected with the readout circuitry through an interconnection.

Meanwhile, according to a related art, since the top portion of the photodiode is connected to ground, extra electrons or extra holes are not reset effectively. Therefore, dark current or reset noise can occur.

Also, according to a related art, since both the source and the drain of the transfer transistor of the readout circuitry are heavily doped with N-type impurities, a charge sharing phenomenon occurs. When the charge sharing phenomenon occurs, the sensitivity of an output image is reduced and an image error may be generated.

Also, according to the related art, because a photo charge does not readily move between the photodiode and the readout circuitry, a dark current is generated or saturation and sensitivity reduce.

### BRIEF SUMMARY

Embodiments of the present invention provide an image sensor that can reduce dark current and reset noise while increasing a fill factor, and a manufacturing method thereof.

Embodiments also provide an image sensor that can reduce occurrence of charge sharing while increasing a fill factor, and a manufacturing method thereof.

Embodiments also provide an image sensor that can minimize a dark current source and inhibit reduction in saturation and sensitivity by providing a swift movement path for a photo charge between a photodiode and a readout circuitry, and a manufacturing method thereof.

In an embodiment, an image sensor can comprise: a first substrate including a interconnection and a readout circuitry; and an image sensing device on the interconnection, wherein a reverse bias is applied to the top side of the image sensing device.

In another embodiment, a method for manufacturing an image sensor can comprise: forming a readout circuitry and an interconnection in a first substrate; and forming an image sensing device on the interconnection, wherein forming the readout circuitry comprises forming an electrical junction region in the first substrate, wherein forming the electrical junction region comprises: forming a first conduction type ion implantation region in the first substrate; and forming a second conduction type ion implantation region on the first conduction type ion implantation region. In addition, the top side of the image sensing device can be applied with a reverse bias.

In another embodiment, an image sensor can comprise: a first substrate including an interconnection and a readout circuitry; and an image sensing device on the interconnection, wherein the first substrate is doped second conduction type, wherein the readout circuitry comprises a transistor on the first substrate and an electrical junction region formed in the first substrate at one side of the transistor. In addition, the top side of the image sensing device can be applied with a reverse bias.

The details of one or more embodiments are set forth in the accompanying drawings and the description below. Other features will be apparent from the description and drawings, and from the claims.

### BRIEF DESCRIPTION OF THE DRAWINGS

FIG. 1 is a cross-sectional view of an image sensor according to an embodiment.

FIGS. 2 to 6 are cross-sectional views of a method for manufacturing an image sensor according to an embodiment.

FIG. 7 is a cross-sectional view of an image sensor according to another embodiment.

### DETAILED DESCRIPTION

Hereinafter, embodiments of an image sensor and a manufacturing method thereof are described with reference to the accompanying drawings.

In the description of embodiments, it will be understood that when a layer (or film) is referred to as being ‘on’ another layer or substrate, it can be directly on another layer or substrate, or intervening layers may also be present. Further, it will be understood that when a layer is referred to as being ‘under’ another layer, it can be directly under another layer, or one or more intervening layers may also be present. In addition, it will also be understood that when a layer is referred to as being ‘between’ two layers, it can be the only layer between the two layers, or one or more intervening layers may also be present.

The present disclosure is not limited to a complementary metal oxide semiconductor (CMOS) image sensor, but can be readily applied to any image sensor requiring a photodiode.

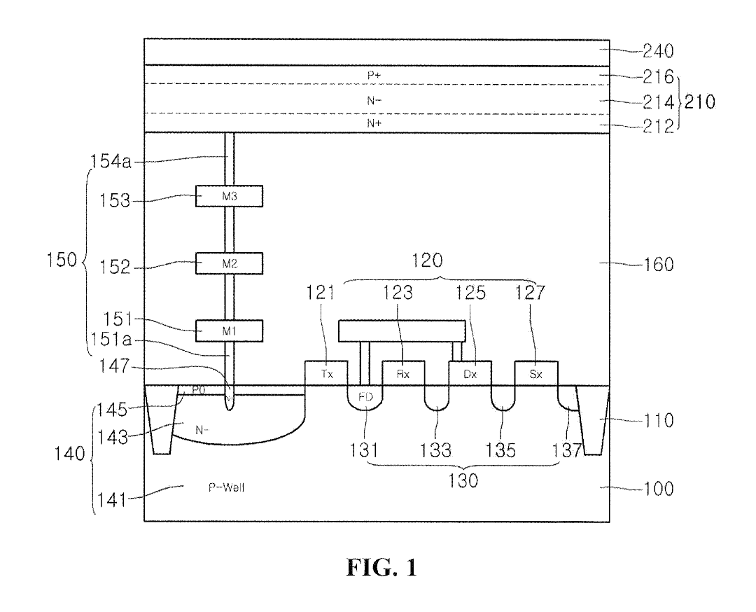

FIG. 1 is a cross-sectional view of an image sensor according to an embodiment.

Referring to FIG. 1, an image sensor can include: a first substrate 100 including an interconnection 150 and a readout circuitry 120; and an image sensing device 210 on the interconnection 150. An upper electrode 240 on the image sensing device 210 is connected such that a reverse bias can be applied to the top side of the image sensing device 210.

The image sensing device 210 can be a photodiode. In another embodiment, the image sensing device 210 can be a photogate or a combination of a photodiode and a photogate. Meanwhile, although the photodiode 210 is described as being formed in a crystalline semiconductor layer, the photodiode is not limited thereto. For example, the photodiode can be formed in an amorphous semiconductor layer.

Reference numerals not explained in FIG. 1 are described in the following manufacturing method.

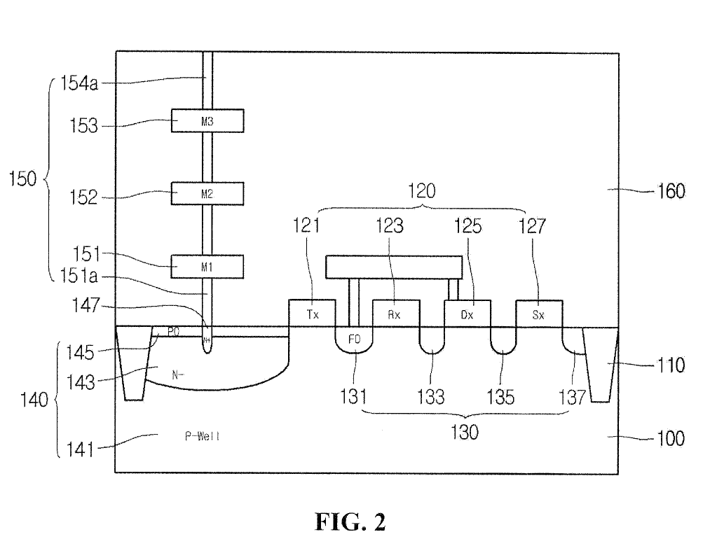

Hereinafter, a method for manufacturing an image sensor according to an embodiment is described with reference to FIGS. 2 to 6.

Referring to FIG. 2, a first substrate 100 in which an interconnection 150 and readout circuitry 120 are formed can be prepared. For example, a device isolation layer 110 can be formed in the second conduction type first substrate 100 to define an active region. The readout circuitry 120 including a transistor can be formed in the active region. In an embodiment, the readout circuitry 120 can include a transfer transistor Tx 121, a reset transistor Rx 123, a drive transistor Dx 125, and a select transistor Sx 127. After forming gates for the transistors, a floating diffusion region FD 131, and ion implantation regions 130 including source/drain regions 133, 135, and 137 of respective transistors can be formed. Also, according to an embodiment, a noise removal circuit (not shown) can be added to improve sensitivity.

The forming of the readout circuitry 120 in the first substrate 100 can include Forming an electrical junction region 140 in the first substrate 100, and forming a first conduction type connection region 147 connected with the interconnection 150 on the electrical junction region 140.

The electrical junction region 140 can be, but is not limited to, a PN junction 140. For example, the electrical junction region 140 can include a first conduction type ion implantation layer 143 formed on a second conduction type well 141 (or a second conduction type epitaxial layer), and a second conduction type ion implantation layer 145 formed on the first conduction type ion implantation layer 143. For example, the PN junction 140 can be, but is not limited to, a P0 (145)/N− (143)/P− (141) junction such as shown in FIG. 2. In one embodiment, the first substrate 100 can be a second conduction type substrate.

According to an embodiment, a device is designed such that there is a potential difference between the source and drain of the transfer transistor Tx, so that a photo charge can be fully dumped. Accordingly, a photo charge generated from the photodiode is fully dumped to the floating diffusion region, so that the sensitivity of an output image can be improved.

That is, according to an embodiment, the electrical junction region 140 is formed in the first substrate 100 where the readout circuitry 120 is formed to allow a potential difference to be generated between the source and the drain of the transfer transistor Tx 121, so that a photo charge can be fully dumped.

Hereinafter, a dumping structure of a photo charge according to an embodiment is described in detail.

Unlike a node of a floating diffusion FD 131, which is an N+ junction, the PNP junction 140, which is an electrical junction region 140 and to which an applied voltage is not fully transferred, is pinched-off at a predetermined voltage. This voltage is called a pinning voltage, which depends on the doping concentrations of P0 region 145 and N− region 143.

Specifically, an electron generated from the photodiode 210 moves to the PNP junction 140, and is transferred to the node of the floating diffusion FD 131 and converted into a voltage when the transfer transistor Tx 121 is turned on.

Since a maximum voltage value of the P0/N−/P− junction 140 becomes a pinning voltage, and a maximum voltage value of the node of the floating diffusion FD 131 becomes a threshold voltage Vth of a Vdd-Rx 123, an electron generated from the photodiode 210 in the upper portion of a chip can be fully dumped to the node of the floating diffusion FD 131 without charge sharing by implementing a potential difference between the sides of the transfer transistor Tx 131.

That is, according to an embodiment, the P0/N−/P−well junction, not an N+/P−well junction, is formed in the first substrate 100, to allow a + voltage to be applied to the N−region 143 of the P0/N−/P−well junction and a ground voltage to be applied to the P0 145 and P−well 141 during a 4-Tr active pixel sensor (APS) reset operation, so that a pinch-off is generated at the P0/N−/P−well double junction at a predetermined voltage or more as in a bipolar junction transistor (BJT) structure. This is called a pinning voltage. Therefore, a potential difference is generated between the source and the drain of the transfer transistor Tx 121 to inhibit a charge sharing phenomenon during the on/off operations of the transfer transistor Tx.

Therefore, unlike a case where a photodiode is simply connected with an N+ junction as in a related art, limitations such as saturation reduction and sensitivity reduction can be avoided.

Next, according to an embodiment, a first conduction type connection region 147 can be formed between the photodiode and the readout circuitry to provide a swift movement path of a photo charge, so that a dark current source is minimized, and saturation reduction and sensitivity reduction can be inhibited.

For this purpose, the first conduction type connection region 147 for ohmic contact can be formed on the surface of the P0/N−/P− junction 140 according to an embodiment. The N+ region 147 can be formed to pass through the P0 region 145 and contact the N− region 143.

Meanwhile, to inhibit the first conduction type connection region 147 from becoming a leakage source, the width of the first conduction type connection region 147 can be minimized. For this purpose, in one embodiment, a plug implant can be performed after a via hole for a first metal contact 151a is etched. In another embodiment, an ion implantation pattern (not shown) can be formed on the first substrate 100 and the first conduction type connection region 147 is then formed using the ion implantation pattern as an ion implantation mask.

That is, a reason for locally and heavily doping only a contact forming portion with N type impurities in this embodiment is to facilitate ohmic contact formation while minimizing a dark signal. In case of heavily doping the entire transfer transistor source, a dark signal may be increased by a Si surface dangling bond.

An interlayer dielectric 160 can be formed on the first substrate 100, and an interconnection 150 can be formed. The interconnection 150 can include, but is not limited to, the first metal contact 151a, a first metal 151, a second metal 152, a third metal 153, and a fourth metal contact 154a.

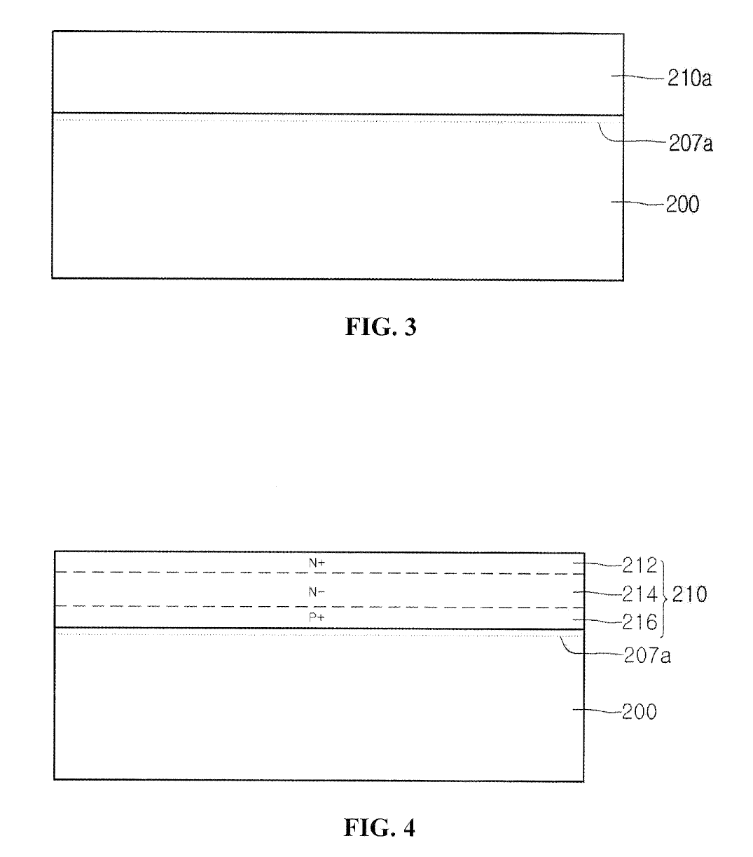

Referring to FIG. 3, a crystalline semiconductor layer 210a can be formed on a second substrate 200. The photodiode 210 can be formed in the crystalline semiconductor layer. Accordingly, according to an embodiment, the image sensing device can adopt a 3-dimensional (3D) image sensor structure located on the readout circuitry to raise a fill factor. In addition, by forming the photodiode 210 inside the crystalline semiconductor layer, defects inside the image sensing device can be reduced.

In an embodiment, the crystalline semiconductor layer 210a can be formed on the second substrate 200 using epitaxial growth. Then, hydrogen ions can be implanted between the second substrate 200 and the crystalline semiconductor layer 210a to form a hydrogen ion implantation layer 207a. In one embodiment, the implantation of the hydrogen ions can be performed after the ion implantation for forming the photodiode 210.

Next, referring to FIG. 4, the photodiode 210 can be formed in the crystalline semiconductor layer 210a using ion implantation. For example, a second conduction type conduction layer 216 can be formed in the lower portion of the crystalline semiconductor layer 210a. In a specific embodiment, a high concentration P−type conduction layer 216 can be formed in the lower portion of the crystalline semiconductor layer 210a by performing blanket-ion implantation on the entire surface of the second substrate 200 without a mask.

After that, a first conduction type conduction layer 214 can be formed on the second conduction type conduction layer 216. For example, a low concentration N−type conduction layer 214 can be formed on the second conduction type conduction layer 216 by performing blanket-ion implantation on the entire surface of the second substrate 200 without a mask.

Then, in a further embodiment, a high concentration first conduction type conduction layer 212 can be formed on the first conduction type conduction layer 214. For example, a high concentration N− type conduction layer 212 can be formed on the first conduction type conduction layer 214 by performing blanket-ion implantation on the entire surface of the second substrate 200 without a mask, so that it can contribute to ohmic contact.

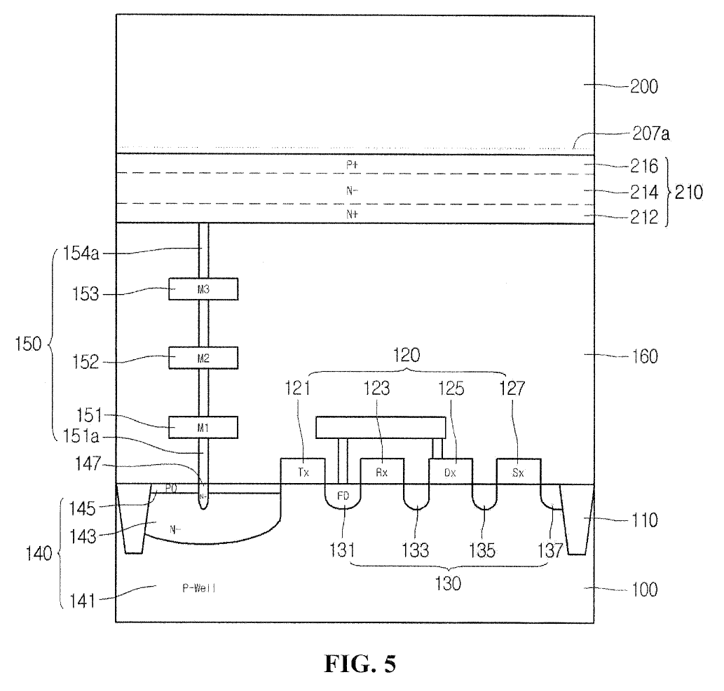

Next, referring to FIG. 5, the first substrate 100 and the second substrate 200 can be bonded such that the photodiode 210 contacts the interconnection 150. At this point, before the first substrate 100 and the second substrate 200 are bonded to each other, the bonding can be performed by increasing the surface energy of a surface to be bonded through activation by plasma. In certain embodiments, the bonding can be performed with a dielectric or a metal layer disposed on a bonding interface in order to improve bonding force.

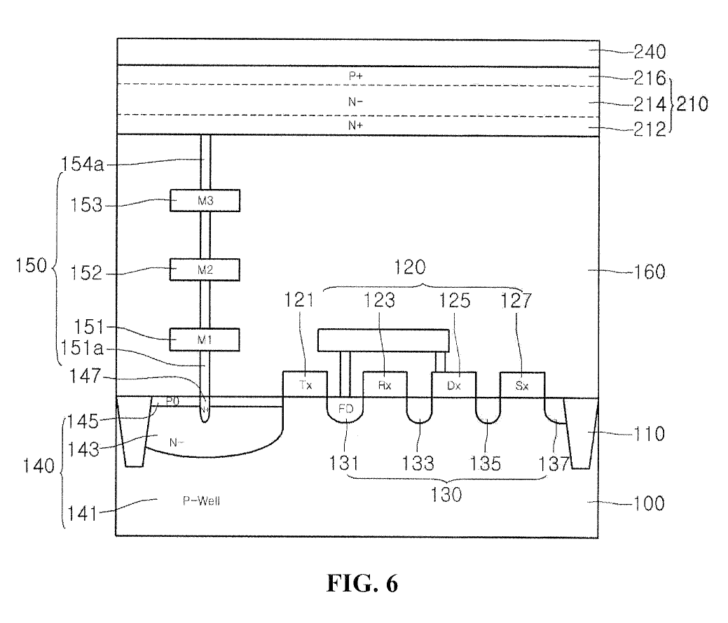

The hydrogen ion implantation layer 207a can be changed into a hydrogen gas layer (not shown) by performing a heat treatment. Then, referring to FIG. 6, a portion of the second substrate 200 can be removed using, for example, a blade leaving the photodiode 210 under the hydrogen gas layer, so that the photodiode 210 can be exposed.

An etching separating the photodiode for each unit pixel can be performed, and the etched portion can be filled with an interpixel dielectric (not shown).

Next, processes for forming an upper electrode 240 and a color filter (not shown) can be performed.

In the image sensor and the manufacturing method thereof according to an embodiment, the image sensor can inhibit dark current or reset noise by applying a strong reverse bias to the top side of the image sensing device to effectively remove extra electrons or extra holes while performing a reseting operation.

That is, according to an embodiment, the image sensor can effectively remove extra electrons or extra holes by appling a strong reverse bias to the top side of the image sensing device to make a strong electric field for the reset transitor while reseting.

TABLE 1

| | Distance of of depletion |
|---|---|
| V_{GND} [V] | @ edge of PD [μm] |
| 0.0 | 0.21 |
| −0.3 | 0.158 |
| −0.5 | 0.147 |

Table 1 shows the effects when a reverse bias is applied to a photodiode according to embodiments of the present invention.

Referring to Table 1, if the top side of the photodiode is just grounded (0.0V applied), as is provided in a related art image sensor the distance of depletion at the edge of the photodiode (PD) is about 0.21 μm.

Meanwhile, according to an embodiment, if −0.3 V is applied to the photodiode, the distance of depletion at the edge of the PD is about 0.158 μm. And if −0.5 V is applied to the photodiode, the distance of depletion at the edge of the PD is about 0.147 μm. Therefore, if reverse bias is applied to the photodiode, the depletion area can be expanded.

That is, according to embodiments, a strong reverse bias can be applied to the top side of the image sensing device to create a high electric field. The voltage difference of the photodiode (V_{GND}+Vdd) is increased due to the high electric field while performing a reset operation (Tx=on, Rx=on).

According to embodiments, the image sensor can effectively remove extra electrons or extra holes by appling a strong reverse bias to the top side of the image sensing device to make a strong electric field for the reset transitor while performing the reset operation. In addition, the depletion area can be expanded by appling the strong reverse bias to the top side of the image sensing device.

Also, according to an embodiment, the device can be designed such that there is a potential difference between the source and drain of the transfer transistor Tx, so that a photo charge can be fully dumped.

Also, according to an embodiment, a charge connection region can be formed between the photodiode and the readout circuitry to provide a swift movement path of a photo charge, so that a dark current source is minimized, and saturation reduction and sensitivity reduction can be inhibited.

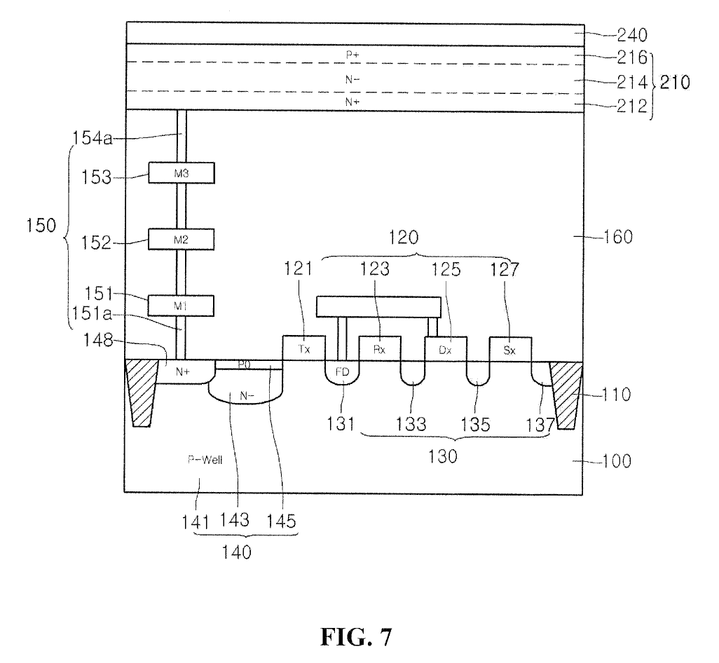

FIG. 7 is a cross-sectional view of an image sensor according to another embodiment, and illustrates a first substrate including an interconnection 150 in detail.

Referring to FIG. 7, the image sensor can include: a first substrate 100 including an interconnection 150 and a readout circuitry 120; and an image sensing device 210 on the interconnection 150, wherein a reverse bias is applied to the top side of the image sensing device 210.

The present embodiment can adopt the technical characteristics of the embodiments described with respect to FIGS. 1 to 6.

Meanwhile, unlike an embodiment described above, a first conduction type connection region 148 is formed at one side of the electrical junction region 140.

According to an embodiment, an N+ connection region 148 for ohmic contact can be formed at the P0/N−/P− junction 140. At this point, a process of forming the N+ connection region 148 and an MIC contact 151a may provide a leakage source because the device operates with a reverse bias applied to the P0/N−/P− junction 140 and so an electric field EF can be generated on the Si surface. A crystal defect generated during the contact forming process inside the electric field serves as a leakage source.

Also, in the case where the N+ connection region 148 is formed on the surface of the P0/N−/P− junction 140, an electric field due to the N+/P0 junction 148/145 is added. This electric field also serves as a leakage source.

Therefore, this embodiment proposes a layout in which a first contact plug 151a is formed in an active region not doped with a P0 layer, but including an N+ connection region 148. Then, the first contact plug 151a is connected with the N−junction 143 through the N+ connection region.

According to embodiments, the electric field is not generated on the Si surface, which can contribute to reduction in a dark current of a 3D integrated CIS.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An image sensor comprising:
a first substrate including an interconnection and a readout circuitry;
an image sensing device on the interconnection; and
an upper electrode on the image sensing device connected such that a reverse bias is applied to the top side of the image sensing device during a reset operation.

2. The image sensor according to claim 1, where the first substrate comprises a p−type substrate.

3. The image sensor according to claim 1, wherein the reverse bias is applied as −3V˜−5V to the top side of the image sensing device.

4. The image sensor according to claim 1, wherein the readout circuitry comprises an electrical junction region formed in the first substrate, wherein the electrical junction region comprises:
a first conduction type ion implantation region in the first substrate; and
a second conduction type ion implantation region on the first conduction type ion implantation region.

5. The image sensor according to claim 4, further comprising a first conduction type connection region between the electrical junction region and the interconnection.

6. The image sensor according to claim 5, wherein the first conduction type connection region is on a portion of the electrical junction region.

7. The image sensor according to claim 5, wherein the first conduction type connection region is in the first substrate at one side of the electrical junction region.

8. The image sensor according to claim 4, wherein the electrical junction region comprises a PNP junction.

9. The image sensor according to claim 1, wherein a potential difference is provided between a source and a drain of a transistor of the readout circuitry.

10. The image sensor according to claim 9, wherein the transistor comprises a transfer transistor and an ion implantation concentration of the source of the transistor is lower than an ion implantation concentration of a floating diffusion region at the drain of the transistor.

11. A method for manufacturing an image sensor, the method comprising:
forming a readout circuitry and an interconnection in a first substrate;
forming an image sensing device on the interconnection; and
forming an upper electrode on the image sensing device for connection to a reverse bias such that the reverse bias is applied to the top side of the image sensing device during a reset operation.

12. The method according to claim 11, wherein forming the readout circuitry comprises forming an electrical junction region in the first substrate electrically connected to the interconnection.

13. The method according to claim 12, wherein forming the electrical junction region comprises forming a first conduction type ion implantation region in the first substrate and forming a second conduction type ion implantation region on the first conduction type ion implantation region.

14. The method according to claim 12, further comprising forming a first conduction type connection region between the electrical junction region and the interconnection.

15. The method according to claim 14, wherein the first conduction type connection region is formed on a portion of the electrical junction region.

16. The method according to claim 15, wherein the first conduction type connection region is formed after forming a contact etching for the interconnection.

17. The method according to claim 14, wherein the first conduction type connection region is formed in the first substrate at one side of the electrical junction region.
